(19) United States
(12) Patent Application Publication
(10) Pub. No.: US 2021/0114842 A1
(43) Pub. Date: Apr. 22, 2021

(54) DEVICES AND METHODS FOR MONITORING INTRINSIC PROPERTIES OF COMPONENTS OF ELEVATOR SYSTEMS

(71) Applicant: thyssenkrupp Elevator Innovation and Operations GmbH, Essen (DE)

(72) Inventor: Michael Palazzola, Horn Lake, MS (US)

(73) Assignee: thyssenkrupp Elevator Innovation and Operations GmbH, Essen (DE)

(21) Appl. No.: 16/654,204

(22) Filed: Oct. 16, 2019

(51) Int. Cl. B66B 7/12; B66B 5/00; G01L 1/22

(52) U.S. Cl. CPC B66B 7/1223; G01L 1/22; B66B 5/0025; B66B 5/0031

(57) ABSTRACT

A device may be disposed on an external surface of a component part of an elevator system. The device may be configured to monitor an intrinsic property of the component part. The intrinsic property may relate to at least one of an amount of strain experienced by the component part, an internal resistance within the component part, or a physical quality of the component part. The device may include a layer of electrically conductive material having an electrode that contacts an electrical connection point. Hence the device may be electrically connected to an external component that conducts performance and/or condition monitoring.

### FIELD

The present disclosure generally relates to elevator systems, including devices and methods for monitoring intrinsic properties of components of elevator systems.

### BACKGROUND

Various techniques are known in the art for monitoring the integrity of elevator supporting means. For instance, a load bearing member can be monitored by determining an associated electrical resistance therein. Such techniques are disclosed in European Patent No. EP1730066B1 and U.S. Patent Publication No. 2013/0207668A1. These techniques, however, require several component parts and/or parts that have complex circuitry. Furthermore, these techniques fail to consider that elevator systems comprise more than just one type of component and that the integrity of various types of components needs to be monitored to ensure passenger safety. To be clear, a technique for monitoring supporting means or load-bearing members may not be suitable for monitoring other parts of elevator systems.

Thus a need exists for an efficient yet accurate way in which to monitor the intrinsic properties of various component parts of elevator systems.

### SUMMARY

In some cases, an example device disposed on an external or an outermost surface of a component part of an elevator system may be configured to monitor an intrinsic property of the component part. In other words, the device may be configured to measure an intrinsic property of the component part. The intrinsic property may comprise an amount of strain experienced by the component part, an internal resistance within the component part, and/or a physical integrity of the component part. Some example devices can conduct performance and condition monitoring at any location on a component part. For example, a device may be used in determining whether a component part of an elevator system is experiencing abnormal strain, abnormal resistance levels, or has a defect and/or a fracture within its macro-/micro-structure.

It should be understood that the term “elevator system” may in some cases refer to all component parts and features of an elevator. The term “component part” may in some cases refer to an elevator shaft, an elevator cabin, elevator doors, a load-bearing member, a drive sheave, a motor, a bedplate, a support beam, or a belt end termination, to name but a few non-limiting examples. In some cases, “component part” may refer to any part of an elevator system that can bend or is susceptible to stress and/or cracking. Furthermore, the terms “external” and “outermost” can be used interchangeably throughout the present disclosure.

Some example devices may comprise at least a first layer of electrically conductive material. The first layer of electrically conductive material may include at least one electrode. The first layer may also comprise an electrical connection point that contacts the electrode. This configuration advantageously provides a way of electrically connecting the device to an external component to conduct the performance and condition monitoring.

In one example, conductive material of the device may comprise a conductive ink. For instance, conductive inks can be applied to an external surface with relative ease and are durable under working conditions. Furthermore, many conductive inks are removable, so the device can be removed from the component part completely when monitoring is no longer required. Additionally or alternatively, a second device can be applied at a different location on the component part by administering a further layer of conductive ink to provide a further electrode. Thus, the example devices of the present disclosure can be retrofitted to any existing component part in an elevator system.

Further, the conductive ink may comprise a conductive metal such as silver, for example and without limitation. In some examples, the conductive ink may also comprise conductive nanoparticles, or a combination of a conductive metal and conductive nanoparticles. This advantageously ensures that the device is always in a conductive state.

Some example devices may comprise at least one further layer, which may comprise an insulating layer, a semi-conductive layer, or an insulating layer and a semi-conductive layer. The insulating layer can be any suitable non-conductive material, and the semi-conductive layer can be any suitable semi-conductive material. Consequently, the device can be configured for its intended purpose. For example, when the device is intended to function as a monitoring device, then at least one further insulating layer may be applied, in some cases at least a first insulating layer on top of the electrically conductive material. If the device is intended to function as a resistor, a semi-conductive layer may also be applied. The semi-conductive layer may be applied on top of the electrically conductive material, and the insulating layer may be applied on top of the semi-conductive layer. If the device is intended to function as, for example, a capacitor or inductor, each layer may be applied as need be for that application.

In some instances, an example device may be visible to the naked eye when disposed on an external surface of the component part. Such visibility may permit a quick and easy assessment of whether the device is configured correctly and can perform its desired function.

Some example devices may be configured to function as a sensor, which sensor includes a resistor such as a strain gauge, a capacitor, or an inductor. Some example devices may be configured to function as a monitoring device where a physical quality of the component part is monitored. For example, the device may be employed to monitor whether there are any cracks or breaks comprised within a load-bearing part. This advantageously provides a reliable way of informing an elevator technician, for example, about the operating condition of a component part of an elevator and consequently facilitates the maintenance and upkeep of the elevator system so it can safely transport passengers.

In some cases the component part to which a device is applied may be a load-bearing member. The load-bearing member may include a plurality of tension members comprised in a non-load bearing jacket material such that the tension members form the load-bearing part. A device may be applied to the non-load bearing jacket material. The device may be physically distinct from the load-bearing part. In other cases, the component part to which the device is applied may be an elevator bed plate, a belt end termination, a drive sheave, a deflector sheave, a part of an elevator that is susceptible to stress and/or cracking, or any combination thereof. Needless to say, the example devices of the present disclosure can be applied to a variety of surfaces within an elevator system and can be configured to function in several different ways in order to ensure a safe operating environment.

Furthermore, at least one electrode of a device may be configured to be electrically connected to an external component such as an electric wire, for example. The external component may be connected to an electrode via any suitable means such as, for example, soldering. Additionally or alternatively, the electrical connection point may be configured to be electrically connected to an external component such as, for example, an electric wire. The external component may be connected thereto via any suitable means such as, for example, soldering. When the electrode and/or the electrical connection point are connected to an external component, any change or variation detected by the electrode and/or the electrical connection point may be transmitted to the external component, which can be further communicated to a monitoring system. The change can be caused, for example, by an increase in strain.

The present disclosure also relates to methods for monitoring intrinsic properties of component parts of passenger elevator systems. One such example method may comprise:
a) applying a device to an external surface of a component part, wherein the device comprises a first layer of an electrically conductive material to provide at least one electrode;
b) in some cases curing the conductive material to provide at least one electrode;
c) applying a further electrically conductive material to the electrode, in some cases at a terminal end of the electrode, to provide an electrical connection point, wherein the electrical connection point is applied at the same time as the electrode or in a separate step thereafter, wherein the electrical connection point can also be cured before any further treatment, such as the addition of further layers, is performed;
d) in some cases applying at least one further layer before step (a), after step (b), after step (c), or any combination thereof;
e) in some cases curing the at least one further layer, although in other cases curing may not be required, for example, if a quick-dry ink is used;
f) establishing an electrical connection between
   (i) the electrode, the electrical connection point, or both the electrode and the electrical connection point and
   (ii) an external component; and
g) processing any transmitted information relating to one or more intrinsic property of the component part via the electric connection to the external component.

The electrical connection may be established via, for example, soldering a wire to the electrical connection point. Any other suitable means can also be used to establish an electric connection between an external component and the device, in particular, the electrode and/or the electrical connection point.

The disclosed devices can be used to conduct performance and condition monitoring. For example, a device can be used in determining whether a component part of an elevator system is experiencing abnormal strain, abnormal resistance levels, or has a defect and/or fracture within its macro-/micro-structure by monitoring the response of the conductive ink. A significant deviation from a normal resistance level may indicate that a component part requires maintenance. A normal resistance level or “baseline” resistance level may be established when the component part is new or first installed, for instance. If, for example, there is a break in the ink, any electrical connection to the external component will break also, thus causing the ink to act as an on/off switch. Likewise, this may indicate that the component part requires maintenance.

In another example method, the at least one further layer comprises a semi-conductive layer and/or an insulating layer. The further layer may be selected based on the desired function of the device.

In some methods, the electrically conductive material may be applied to the component part or, more specifically, to the external surface of the component part via a stamping process, brushing on with a stencil, a syringe application, and/or a hand gun application. This advantageously provides a variety of quick and easy-to-use application methods.

Still further, in some example methods the further electrically conductive material may be applied to the component part or, more specifically, to the external surface of the component part via a stamping process, brushing on with a stencil, a syringe application, and/or a hand gun application. This advantageously provides a variety of quick and easy-to-use application methods.

According to some methods, the external surface comprises at least one of a jacket of a load bearing member, where in some cases the jacket is non-load-bearing; a bedplate; a belt end termination; and/or an insulating layer, which in some cases is applied to at least one of the aforementioned items in the list. This advantageously provides a device that can be configured to suit numerous external surfaces comprised within an elevator system.

Still further yet, the present disclosure concerns an elevator system that comprises a plurality of component parts, at least one of which includes an example device as disclosed herein. The device may be applied to the component part using one of the example methods disclosed herein.

### BRIEF DESCRIPTION OF THE FIGURES

FIG. 1 is a schematic perspective view of a component part of an elevator that includes an example device on its external surface.

FIG. 2 is a schematic perspective view of the component part of an elevator that includes another example device on its external surface.

FIG. 3 is a schematic perspective view of the component part of an elevator that includes still another example device on its external surface.

FIG. 4 is a cross-sectional view of a load-bearing member comprising the example device of FIG. 1 disposed within a belt end termination.

FIG. 5a is a perspective view of a pulley system positioned on top of an elevator shaft.

FIG. 5b is a perspective view of a pulley system positioned on top of an elevator shaft wherein a component part of the pulley system comprises an example device.

FIG. 6 is a flowchart depicting an example method for applying the example device of FIG. 1 to a component part of an elevator.

### DETAILED DESCRIPTION

Although certain example methods and apparatuses are described herein, the scope of coverage of this patent is not limited thereto. On the contrary, this patent covers all methods, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claim need not necessarily be performed in the order in which they are recited, unless so required by the context of the claims. In addition, all references to one skilled in the art shall be understood to refer to one having ordinary skill in the art. With respect to the drawings, it should be understood that not all components are drawn to scale and that the drawings are not necessarily to scale. Rather, the drawings present a simplified representation of various features illustrative of the basic principles of the present disclosure. The specific design features of the present disclosure such as, for example, dimensions, orientations, locations, and shapes will be determined by the particular application and use environment. Furthermore, those having ordinary skill in the art will understand that the various examples disclosed herein should not be considered in isolation. Instead, those with ordinary skill in the art will readily understand that the disclosure relating to some examples may be combined with and/or equally applicable to the disclosure relating to other examples.

The present disclosure generally relates to devices that may be disposed on an external surface of a component part of a passenger elevator system for monitoring an intrinsic property of the component part. In some examples, the intrinsic property may relate an amount of strain experienced by the component part, an internal resistance within the component part, and/or a physical quality of the component part. The present disclosure may also generally relate to passenger elevator systems that include such devices. Still further, the present disclosure may further relate to methods of monitoring intrinsic properties of component parts of passenger elevator systems.

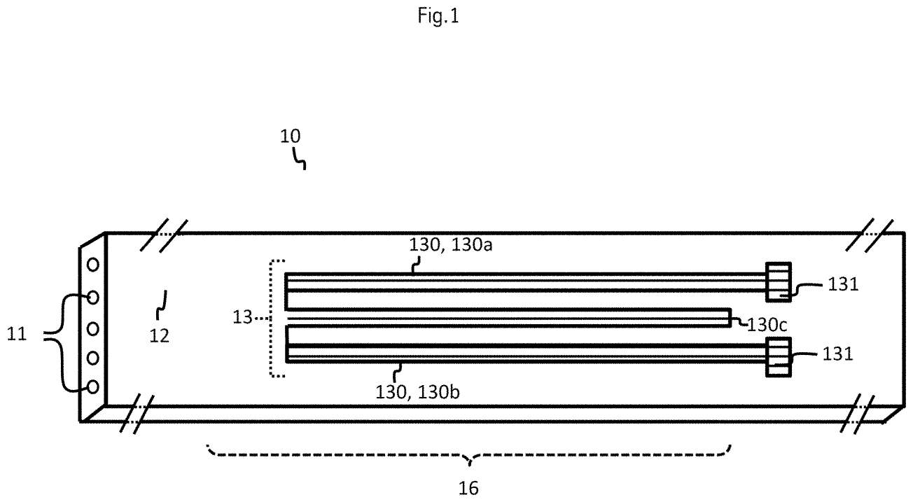

FIG. 1 shows a component part of an elevator 10 comprising an example device 13. In this particular example, the component part 10 is a load-bearing member, which is subject to significant bending stress and tension. The load-bearing member 10 comprises a plurality of tension members 11 surrounded by or embedded in a polymer material 12. In this example, the polymer material 12 holds the tension members in position and provides the external surface whereon the device 13 is applied. The polymer material 12 may be a non-conductive material such as, for example and without limitation, polyurethane or epoxy resin. In some instances the polymer material 12 may be coated with a jacket material. In such instances, the jacket may become the external surface 12 whereon the device 13 is applied. The polymer material and the jacket material can be the same or different.

The example device 13 in FIG. 1 further comprises an electrode 130 and an electrical connection point 131 at a terminal end thereof. In some examples, electrical connection points may be disposed at both terminal ends of the electrode 130. Notwithstanding, the electrode 130 may comprise a first electrode 130a, a second electrode 130b, and a connector 130c. The connector 130c inter-connects the first and second electrodes 130a, 130b. In this particular example, the device 13 is configured to act as a resistor and, more particularly, as a strain gauge.

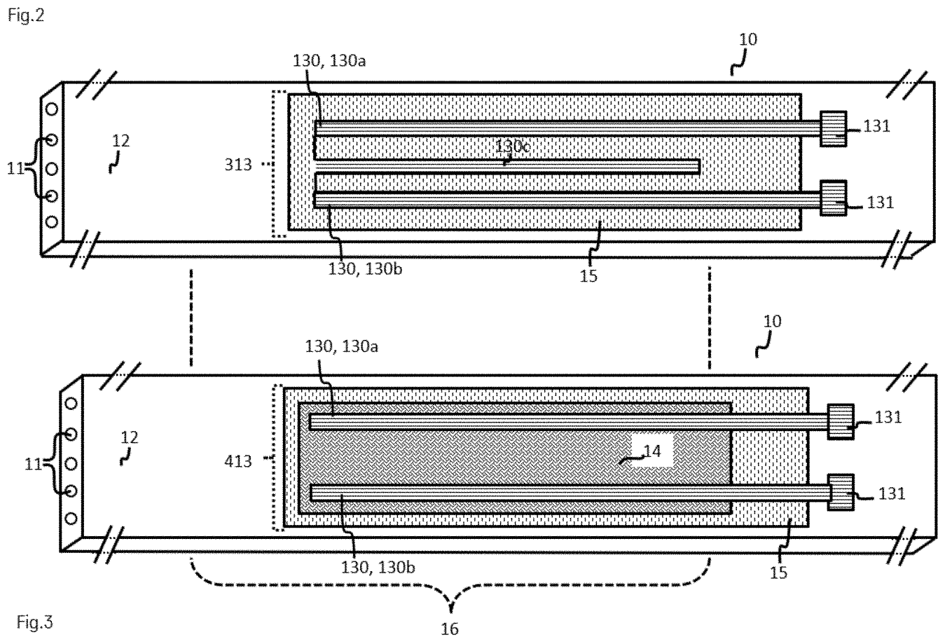

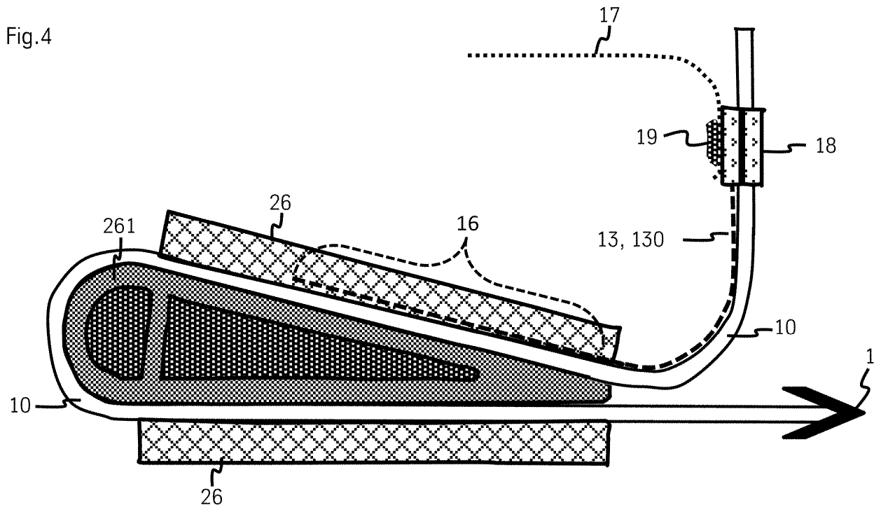

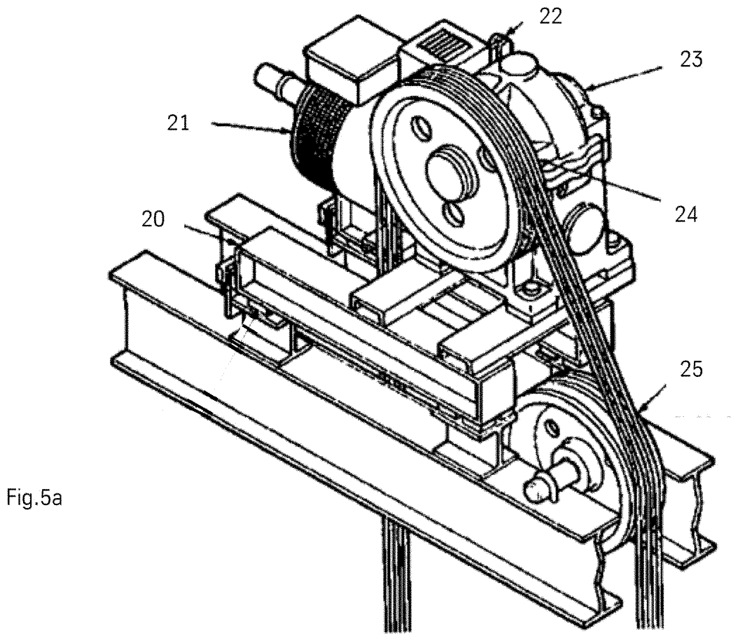

The electrode 130 may be administered first to the external surface 12 of the load-bearing member 10 as a conductive ink, which is then cured. In this example, application of the ink to the polymer material 12 and curing may be performed simultaneously such that the ink is immediately conductive and the resulting electrode 130 can be used as an electrical connection terminal. The electrical connection point 131 may be applied to a terminal end of the electrode 130. A first electrical connection point 131 may be applied at the terminal end of the first electrode 130a, and a second electrical connection point 131 may be applied at the terminal end of the second electrode 130b. It should be understood, however, that an electrical connection can be made at any point along the electrode 130, namely, along the first electrode 130a, the second electrode 130b, the third electrode 130c, and/or at the connection point 131. The exact position of the electrical connection may ultimately depend upon the intended use and whether any further layers, as illustrated in FIGS. 2 and 3, for instance, are to be applied to the external surface 12. In the example in FIG. 1, a portion of the load-bearing member 10 corresponding to the reference numeral 16 is the portion 16 that is comprised within a belt end termination, as illustrated in FIG. 4, for instance. The electrical connection of the strain gauge device 13 may thus be made at the electrical connection point 131 since the electrical connection point 131 is not disposed within the belt termination end.

FIG. 2 shows another example device 313, which may include many or all of the same elements of the example device 13 of FIG. 1. However, the device 313 shown in FIG. 2 may further comprise an insulating layer 15 that is applied to the electrode 130 and cured such that the electrical connection points 131 and a specific uncovered area of the electrode 130 remain uncovered and thus available for connection to an external component 17, such as shown in FIG. 4, for example. In the example of FIG. 2, the specific uncovered area comprises the first electrode 130a and the second electrode 130b and their respective electrical connection points 131. The connector 130c may be completely disposed within the insulating layer 15. The insulating layer 15 can be any suitable non-conductive material. The introduction of an insulating layer can help prevent short-circuiting. When such an insulating layer 15 is applied, the device 313 may be configured to act as a capacitor. In this example, the portion 16 of the load-bearing member 10 may be disposed within the belt end termination, as shown in FIG. 4. The electrical connection may thus be made at the electrical connection point 131 since it is neither disposed within the belt end termination nor is it covered by the insulating layer 15.

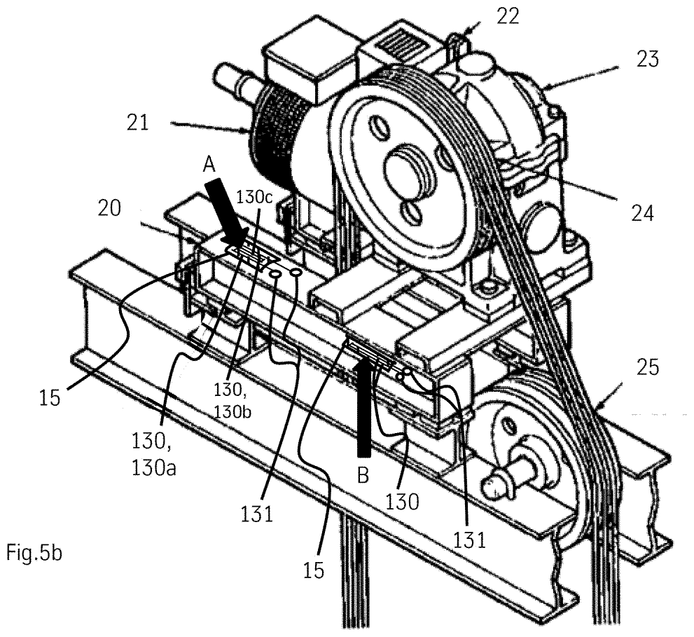

The device 313 can comprise a further insulating layer that is applied to the external surface 12 of the load-bearing part 10 before the electrode 130 and the electrical connection point 131 are applied. Thus, the electrode 130 and the electrical connection point 131 may be applied to the further insulating layer instead of the external surface 12 of the load-bearing part 10. Such an arrangement may be advantageous when the external surface 12 to which the device 313 is applied is a bare, conductive piece of metal. Hence a component part of an elevator such as a metallic bed plate 20 (FIGS. 5A, 5B), for instance, can comprise a device 313 with the first insulating layer 15, a layer comprising an electrode 130, and an electrical connection point 131 at a terminal end thereof, as well as a further insulating layer. In some cases, the component part may include these elements in that respective order. In examples like these, the device 13 may be configured to act as a resistor. As explained above, the electrode 130 may comprise the first electrode 130a, the second electrode 130b, and the connector 130c, with the connector 130c providing the connection between the first and second electrodes 130a, 130b.

FIG. 3 shows another example device 413, which may include many or all of the same elements of the example device 13 of FIG. 1 and/or the example device 313 of FIG. 2. For instance, the example device 413 shown in FIG. 3 may comprise the electrode 130, which in turn comprises the first electrode 130a and the second electrode 130b. The first and second electrodes 130a, 130b may each comprise the electrical connection point 131 at the respective terminal ends thereof, the insulating layer 15, and a further layer 14. The further layer 14 may comprise a semi-conductive material. In some examples, the order in which the respective layers are applied to the external surface 12 of the load-bearing part 10 is a first layer comprising the electrode 130; a second layer comprising a semi-conductive material, wherein the second layer is the further layer 14, namely, a semi-conductive layer 14; and a third layer comprising an insulating material, wherein the third layer is the insulating layer 15. The example device 413 in FIG. 3 may also be configured to act as a resistor and, more particularly, as a strain gauge.

The semi-conductive layer 14 may comprise a material comprising carbon, in some cases, a carbon mixture ink. The semi-conductive layer 14 may be applied on top of the electrode 130 and then cured. This semi-conductive layer 14 may inter-connect the first electrode 130a and the second electrode 130b. By inter-connecting the first and second electrodes 130a, 130b in this way, a pressure/force measurement can be obtained. The insulating layer 15 may be applied on top of the semi-conductive layer 14 and, in some cases, cured. A specific uncovered area may be available for connection to the external component 17 such as a wire, as shown in FIG. 4, for example. The specific uncovered area of the resistor device 413 may comprise the electrical connection point 131 and a length of the first and second electrodes 130a, 130b leading into the connection point 131. The insulating layer 15 may be a suitable non-conductive material. In this example, the insulating layer 15 may be the same material as the jacket material 12, for example, polyurethane. The introduction of the insulating layer 15 may advantageously prevent short-circuiting when the load-bearing member 10 is provided to a belt end termination 26, as shown in FIG. 4 where the portion 16 of the load-bearing member 10 is disposed within the belt end termination 26. The electrical connection may thus be made at the electrical connection point 131 since it is neither disposed within the belt termination end nor is it covered by the insulating layer 15.

FIG. 4 shows a cross-section of the load-bearing member 10 comprising the example device 13 of FIG. 1. The portion 16 of the load-bearing member 10 may be comprised within the belt end termination 26 and held in place via a belt end termination wedge 261. As disclosed above, the example device 13 may be configured to act as a resistor and, more particularly, a strain gauge. The portion 16 of the load-bearing member 10 may have at least one electrode 130 disposed thereon. The part of the strain gauge 13 not comprised within the belt end termination 26, which part may comprise at least one electrical connection point 131 and at least a length of at least one electrode 130, may remain outside the belt end termination 26 to be contacted by the external component 17. In this example, the external component 17 may be a wire. The electrical connection point 131 may be disposed within a conductive connector 18, and the external component 17 may be attached thereto via a solder 19. However, any means of electric connection can be used. When a load is applied to the load-bearing part 10, as in when the load-bearing part 10 is connected to and supporting an elevator cabin, the electrodes 130 will either expand or contract depending on the operation of the elevator (e.g., ascending, descending, or remaining at a certain floor). This expansion or contraction causes the internal resistance in each respective electrode 130 to increase or decrease respectively. Based on the change in resistance, the total strain on the external surface 12 of the load-bearing member 10 can be calculated as well as the load experienced by the load-bearing member 10.

When one of the example devices disclosed herein is applied to an external surface of another component part of an elevator, which component part may be the belt end termination 26, a bedplate, or some other part, the same system of monitoring the reaction of the device can be used. For example and without limitation, the monitoring may be based on the expansion or contraction of the electrode 130 in response to an applied load, the change in resistance, and/or the capacitance of the electrode 130. The example devices disclosed herein can also be used as load-weighing substitutes, wherein such a device, when used as a strain gauge, can determine the load in an elevator cabin instead of using a traditional car load-weighing device. Thus the example devices disclosed herein help improve safety standards within the elevator system as a whole.

FIG. 5a shows a perspective view of one aspect of an example elevator system, including a drive motor 21, a brake 22, a gear box 23, a drive sheave 24, and a deflector sheave 25 with a component part 20 of an elevator. In the example shown here, the component part 20 is a bedplate of an elevator.

FIG. 5b shows the bedplate 20 comprising the example device 13 configured to act as a strain gauge. The device 13 may be applied to the external surface of the bedplate 20 and, as explained above, may comprise the insulating layer 15, the electrode 130, and the electrical connection point 131. More particularly, the device 13 may comprise the first electrode 130a and the second electrode 130b, each of which comprises the electrical connection point 131. The device 13 may also include the connector 130c, which is shown at location A. The insulating layer 15 may be applied first to the bedplate 20 since the bedplate 20 is metallic. The electrode 130 and the electrical connection point 131 may be applied on top of the insulating layer 15. In some cases, a further insulation layer may be applied on top of the electrode 130. The device 13 can be applied to any one location or at a plurality of locations on the surface of the bedplate 20, although in the example shown the device 13 is applied at the location A. However the device 13 could also be applied at location B, for example and without limitation. What's more, the present disclosure contemplates that a combination of devices can be dispersed throughout the external surface of the bedplate 20 at various locations, for example, at location A and location B, or location A and location B and/or any other location on the surface of the bedplate 20.

One or more external surfaces of any component part 10, 20, 26, in an elevator system can comprise one or more devices according to the present disclosure. As explained above, the device can be configured to act as a resistor (e.g., a strain gauge) a capacitor, or another monitoring means.

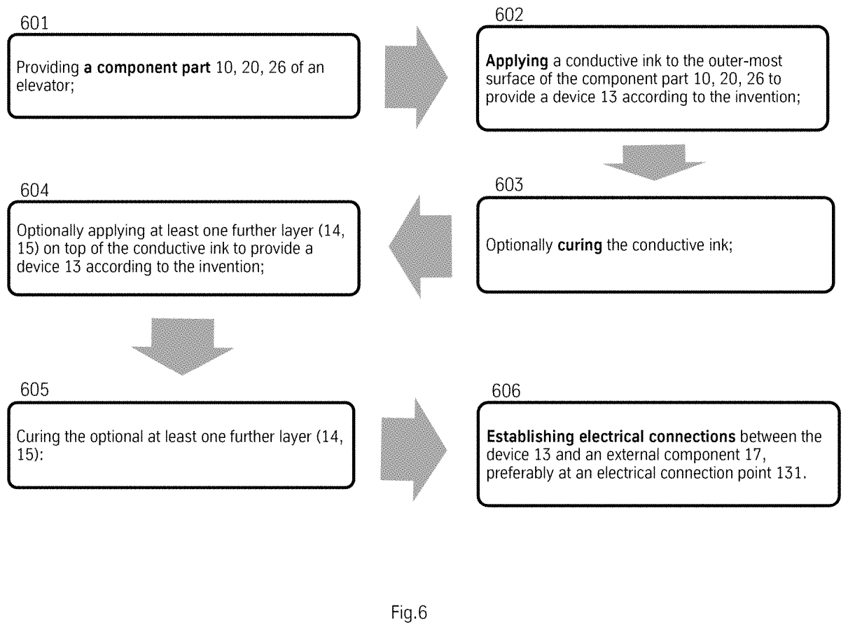

FIG. 6 is a flowchart depicting an example method of the present disclosure. In step 601 at least one component part 10, 20, 26 of an elevator is provided. The component part may comprise at least one of the load-bearing member 10, the bedplate 20, the belt end termination 26, the drive sheave 24, the deflector sheave 25, or any component part of an elevator system that is susceptible to stress and/or cracking. In step 602, the device 13 may be applied to an external surface of the component part 10, 20, 24, 25, 26. The device 13 may comprise the electrode 130, and the electrode 130 may comprise at least one of the first electrode 130a, the second electrode 130b, the connector 130c, the one or more electrical connection point(s) 131, or one or more of the further layers 14, 15. Those having ordinary skill in the art will understand that although the example methods disclosed with respect to FIG. 6 reference the example device 13 of FIG. 1, these and other methods may employ a wide variety of other types of devices consistent with the spirit of the present disclosure, including the example device 313 of FIG. 2 or the example device 413 of FIG. 3, for instance.

When the external surface of the component part 10, 20, 24, 25, 26 is non-metallic, the conductive ink may be applied directly thereto and, in some cases, cured in step 603 to provide the electrode 130. The electrical connection point 131 can be comprised of conductive ink or of a conductive material connected to said conductive ink. The electrical connection point 131 can be cured.

Whether the ink needs to be cured or not may depend on the type of conductive ink used. Some conductive inks do not require a curing step and are immediately conductive upon application to a surface. The conductive ink used in this example may comprise 1 Part Heat Dry Electrically Conductive, Silver Epoxy Adhesive AA-DUCT AD1. Other example conductive inks include:
Electrically Conductive Epoxy, Silver Adhesive, Room Temperature Cure, Air Dry AA-DUCT 902; inks from conductive ink pens; or conductive inks that are curable at room temperature. In some examples, the conductive ink may comprise silver particles. Still further, the conductive ink used in this example has the following properties:
a) Viscosity 200,000 Cp, Shelf Life 4 months at 25° C., 6 months refrigerated;
b) Mechanical Properties Hardness, Shore D 83, Appearance Silver;
c) Low Volume Resistivity;
d) Operating Temperature Up to 325° C., Cure Type Heat cure; and
e) Cure Time 30 minutes at 175° C., 1 hour at 150° C., 2 hours at 125° C.

The conductive ink can be applied using a variety of methods. For example, the method may involve a stamping process, brushing on with a stencil, a syringe application, a hand gun application. In some application methods, for example, when using a hand gun, it is possible to administer and cure the conductive ink simultaneously. When simultaneous administration and curing is not possible, then a curing step may follow the administration step provided that the conductive ink requires a curing step to activate its conductivity. The conductive ink can likewise be cured using a variety of methods. For example, curing may involve air drying; UV or “blue” light; and/or a heat gun such as, for example, a domestic hairdryer or a purpose-built heat gun.

Step 604 relates to applying at least one further layer 14, 15 on top of the electrode 130. Step 604 may in some cases depend on whether the device 13 is to be used as a resistor (e.g., a strain gauge), a capacitor, or a monitoring means. Step 604 may also depend on where the device 13 is to be positioned within the elevator system. For example, when the device 13 is applied on the load-bearing member 10 at least partially within the belt end termination 26 or on the bedplate 20, the device 13 can comprise at least one further layer on top of the electrode 130. The further layer can comprise the semi-conductive layer 14, the insulating layer 15, or a combination of the semi-conductive layer 14 and the insulating layer 15.

Each further layer applied may be individually applied and cured in step 605. Similar to the conductive ink application, any further layer can be applied and cured simultaneously. If simultaneous application and curing is not possible, then a curing step may follow the application step.

The example device 13, at least when applied to part of the load-bearing member 10 that is to be inserted into the belt end termination 26, may comprise the insulating layer 15 applied on top of the electrode 130 in order to prevent short-circuiting between the electrode 130 and the belt end termination 26. The device 13 can comprise the semi-conductive layer applied on top of the electrode 130 and the insulating layer 15 applied on top of the semi-conductive layer 14. This may be advantageous when a variant of the electrode 130 comprises the first electrode 130a and the second electrode 130b, but lacks the connector 130c. The semi-conductive layer 14 serves to interconnect the first electrode 130a and second electrode 130b, whereas the insulating layer 15 prevents short-circuiting. In both alternatives, the device 13 can be configured to act as a resistor (e.g., a strain gauge), a capacitor, or a monitoring means.

When the external surface of the component part 10, 20, 24, 25, 26 is metallic, the device 13 may comprise the insulating layer 15 that is first applied to the external surface of the component part 10, 20, 24, 25, 26 and cured. The conductive ink may then be applied to the insulating layer 15 in the same way as outlined above and, in some cases, cured to provide an electrode 130. The electrode 130 can comprise any one or combination of a first electrode, a second electrode, or a connector 130c, as explained above. As also explained above, the electrical connection point 131 may be comprised of conductive ink or of a conductive material connected to said conductive ink. The electrical connection point 131 can be cured.

Once the device 13 is in place, electrical connections to external components 17 may be established in step 606. By way of example, establishing an electrical connection to the external component 17 may involve soldering a wire to the electrical connection point 131, or soldering a wire to the electrode 130. To reiterate, whether the external component 17 is connected to the device 13 at the electrode 130 or the electrical connection point 131 may depend on the desired application and the component part to which the device 13 is applied.

### REFERENCE LIST

1 load (elevator cabin)

10 load-bearing part

11 tension member

12 polymer material/external surface

13 device

130 electrode

130a, b electrode

130c connector

131 electrical connection point

14 semi-conductive layer

15 insulating layer

16 portion of load bearing member comprised within belt termination end

17 external component

20 bedplate

21 drive motor

22 brake

23 gear box

24 drive sheave

25 deflector sheave

26 belt end termination

261 belt end termination wedge

313 device

413 device

What is claimed is:

1. A device configured to be disposed on an external surface of a component part of an elevator system, wherein the device is configured to monitor an intrinsic property of the component part, the intrinsic property relating to at least one of:
strain within the component part;
internal resistance within the component part; or
physical integrity of the component part.

2. The device of claim 1 comprising a first layer of electrically conductive material, wherein the first layer of electrically conductive material comprises an electrode.

3. The device of claim 2 wherein the electrically conductive material comprises a conductive ink.

4. The device of claim 3 wherein the conductive ink comprises at least one of a conductive metal or conductive nanoparticles.

5. The device of claim 1 comprising a further layer that is an insulating layer or a semi-conductive layer.

6. The device of claim 1 wherein the device is visible to a naked eye when disposed on the external surface of the component part.

7. The device of claim 1 configured to function as a sensor or a monitoring device.

8. The device of claim 1 wherein the component part is at least one of a load bearing member, an elevator bed plate, or a belt end termination.

9. The device of claim 1 wherein the electrode is configured to be electrically connected to an external component.

10. A method of monitoring an intrinsic property of a component part of an elevator system, the method comprising steps of:
applying a device configured to monitor the intrinsic property of the component part to an external surface of the component part, the device comprising a first layer of an electrically conductive material, which provides an electrode;
applying a further electrically conductive material to a terminal end of the electrode to provide an electrical connection point;
establishing an electric connection between
the electrode and/or the electrical connection point, and
an external component; and
processing information relating to the intrinsic property of the component part that has been transmitted via the electric connection to the external component.

11. The method of claim 10 comprising curing the electrically conductive material to provide the electrode.

12. The method of claim 11 comprising applying a further layer
before applying the device to the external surface of the component part,
after curing the electrically conductive material, and/or
after applying the further electrically conductive material to the terminal end of the electrode.

13. The method of claim 12 comprising curing the further layer.

14. The method of claim 12 wherein the further layer comprises a semi-conductive layer or an insulating layer.

15. The method of claim 10 comprising applying the electrically conductive material of the device to the external surface of the component part via at least one of:
a stamping process;
brushing on with a stencil;
a syringe application; or
a hand gun application.

16. The method of claim 15 comprising applying a further electrically conductive material to the terminal end of the electrode via at least one of:
a stamping process;
brushing on with a stencil;
a syringe application; or
a hand gun application.

17. The method of claim 10 wherein the external surface comprises at least one of:
a jacket of a load bearing member;
a bedplate;
a belt end termination; or
an insulating layer.

18. An elevator system comprising:
a plurality of component parts; and
a device disposed on an external surface of at least one of the plurality of component parts, the device being configured to monitor an intrinsic property of at least one of the plurality of component parts, wherein the intrinsic property relates to at least one of:
strain within the component part,
internal resistance within the component part, or
physical integrity of the component part,
wherein a first layer of an electrically conductive material of the device is attached to the external surface of the component part as an electrode, wherein a further electrically conductive material is attached to a terminal end of the electrode to provide an electrical connection point, wherein the electrode and/or the electrical connection point are configured to be electrically connected to an external component to transmit information regarding the intrinsic property to the external component.
